(19) United States
(12) Patent Application Publication
(10) Pub. No.: US 2008/0008791 A1
(43) Pub. Date: Jan. 10, 2008

(54) Frozen Aerated Product

(76) Inventors: Alexander Aldred, Sharnbrook (GB); Tommaso D'Agostino, Sharnbrook (GB); Nicholas Charles A Evans, Biddenham (GB); Jingfei Wang Evan, Bedford (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/582,197

(22) PCT Filed: Nov. 24, 2004
(86) PCT No.: PCT/EP04/13414

§ 371 Date: Aug. 6, 2007

(30) Foreign Application Priority Data
Dec. 9, 2003 (EP) 03257721.5

(51) Int. Cl. A23G 9/46

(52) U.S. Cl. 426/101

(57) ABSTRACT

A self-sustaining log shaped frozen aerated product is produced by cold-extruding a low fat formulation at a temperature between −15° C. and −24° C. in order to achieve an ice content at −18° C. of between 30% and 55%.

### TECHNICAL FIELD OF THE INVENTION

The present invention relates to a frozen aerated product such as an ice cream. It more particularly relates to a frozen aerated product in the form of a log. It particularly relates to frozen aerated products produced by extruding a soft formulation.

### BACKGROUND OF THE INVENTION

Frozen aerated products are normally produced using a scraped surface heat exchanger (SSHE). The products manufactured using such equipment must be stable at the temperature at which they are produced, namely around −6 to −10 C. By stable it is meant that the product must be rigid enough to sustain its own weight until and when the product is directed towards a hardening tunnel wherein the product is typically brought down to a temperature of −20° C. During this hardening step, the ice cream product typically moves from an ice content of around 30% (at the exit of the SSHE) to an ice content of at least 45%.

Certain formulations are too soft to allow for a product like a log to be produce by extrusion at the exit of a SSHE. There is a need for producing an extruded log-shaped frozen aerated product with a formulation which is such that the product cannot sustain its shape under standard manufacturing conditions.

It has now been found that it is possible to produce log-shaped frozen aerated products which were not possible to produce before by carefully choosing the processing conditions.

Tests and Definitions

Ice Content

Ice content is measured by adiabatic calorimetry as described by de Cindio and Correra in the Journal of Food Engineering (1995) 24 pp. 405-415. More specifically this was described for complex ice cream analysis by Jarvis, D. at the Inter-Ice Conference (2000) in Solingen, Germany. It is expressed in % (w/w) based on the total weight of the frozen aerated product.

Overrun

Overrun is defined by the following equation

$$O R = \frac{volume of ice cream - volume of mix at ambient temp}{volume of mix at ambient temp} \times 100$$

It is measured at atmospheric pressure.

Log-shaped

By log shaped it is meant any product having a generally constant cross section. The cross-section may be generally rectangular, triangular, circular or lenticular. Log shaped product are typically produced by extrusion.

Aspect Ratio

The aspect ratio is defined as the ratio of the height of the cross section of the log to its width.

Stabilisers

Any of the list of biopolymers typically used in ice cream at levels for thickening but not forming a supporting gel network at extrusion. Preferably, stabilisers used in the present invention are selected from the group consisting of alginates, guar gum, xanthan gum, locust bean gum, gum arabic, gum karaya, gum tragacanth, tara gum, oat gum, furcellaran, carrageenans, gelatine, agar, sodium carboxymethylcellulose, microcrystalline cellulose, methyl cellulosics, low and high methoxy pectins and mixtures thereof.

Emulsifiers and Aerating Agents

Emulsifiers and aerating agents (in non-fat systems) included are those typically used in ice-cream manufacture (defined as in Ice Cream 6^{th} Edition, Marshall et al. (2003), pp. 85-86).

Total Solids

The dry weight of the system as measured using the oven drying method as described in Ice Cream 6^{th} Edition, Marshall et al. (2003), p. 296.

Fat Content

The fat used may be a dairy fat, a non-dairy fat or a mixture of both. When the fat is a dairy fat, it may be any milk fat source such as butter oil, butter, cream or a mixture thereof. A non-dairy fat is an edible oil or fat, preferably a vegetable oil such as palm oil, coconut oil or mixtures thereof, or an hydrogenated fat. Fat content can be measured by methods described in Pearsons Chemical Analysis of foods, 1991, 8^{th} edition, pp 502.

Milk-Solids Non-Fat

The milk solids non-fat (MSNF) contains milk proteins and lactose. MSNF may be provided by using dried milk, liquid milk or concentrated milk products and typical examples include dried whole milk, dried skimmed milk, dried whey, liquid milk, concentrated milk products and mixtures thereof.

Freezing Point Depressants

Sugars and sugar alcohols can be used to depress the freezing point and manipulate the ice content of the product on extrusion. Sugars typically included are sucrose, fructose, glucose, lactose, dextrose, invert sugar and corn sugars or mixtures thereof which can be included in either a crystalline or liquid form. Mono- and disaccharide sugar alcohols such as sorbitol, mannitol, xylitol, erythritol, lactitol, maltitol, isomalt and related starch hydrolysates can also be used as a full or partial replacement to the sugars for the purpose of freezing point manipulation.

Fruit Content

In Europe, the industry accepted guidelines recommend that sorbets contain a minimum fruit content of 25%, or 15% for citrus and exotic fruits (see Sorbets et Cremes Glaces, Code Euroglaces, Syndicat des Fabricants Industriel de Glaces). This fruit is included usually in the form of a fruit juice or “puree”. The latter meaning an homogeneous product prepared from whole or peeled fruit of good maturity which has been pulped by a suitable physical process (see Revised Draft Codex General Standard for Fruit Juices and Nectars, National Juice Product Association 2001). The puree and juices may or may not have had a portion of the water physically removed and optionally sugars added. The fruit purees or juices contain dietary fibre (soluble and insoluble) which is defined as food material particularly plant material that is not hydrolysed by enzymes secreted by the human digestive tract but that may be digested by microflora in the gut. The total fruit equivalent can be calculated from the measured amount of dietary fibre (“Total, soluble and insoluble dietary fibre in foods”, AOAC International (1995), Method 991.43, Official Methods of Analysis, 16^{th} Edition). The dietary fibre may be derived from fruits or vegetables from one or more fruit puree or juice, one or more vegetable purees or mixtures thereof and additionally from added celluloses, hemicelluloses, pectic substances, gums, mucilages, lignins and modified polysaccharides such as carboxymethylcellulose.

### BRIEF DESCRIPTION OF THE INVENTION

It is the object of the invention to provide a frozen aerated log-shaped product containing less than 4.5% w/w fat, having an overrun of between 30% and 120% and an ice content of between 30% and 55% (w/w) at a temperature of −18° C. characterised in that the frozen aerated product is log-shaped and has an aspect ratio of between 0.8:1 and 2:1, preferably between 0.8:1 and 1.5:1.

It has been found surprisingly that, by using cold extrusion it is possible to get stable log-shaped extruded structures which would otherwise collapse under their own weight.

Preferably, the log-shaped frozen aerated product is at least 4 cm high.

Preferably also, the frozen aerated product according to the invention contains less than 1% w/w stabiliser, more preferably not more than 0.5% w/w.

Preferably also, the frozen aerated product has a total solids content of between 25 and 50% (w/w).

### DETAILED DESCRIPTION OF THE INVENTION

The present invention will be further described with reference to the following examples.

### Sorbet Examples

Various sorbet formulations were produced as described in Table 1.

TABLE 1
Extruded Sorbet Formulations

| | Example Product | | | | | | | |
|---|---|---|---|---|---|---|---|---|
| | 1 | 2 | 3 | 4 | 5 | 6 | 7 | 8 |
| | Sorbet | Sorbet | Sorbet | Sorbet | Sorbet | Sorbet | Sorbet | Sorbet |
| Formulation | | | | | | | | |
| Dextrose | 17 | 14 | 4 | 8 | 16 | 10 | 3 | 3 |
| Sucrose | 19.5 | 16 | 16 | 9.9 | 23.5 | 23 | 23 | 17 |
| Glucose Syrup | 6.5 | 6.6 | 6 | 5.5 | 5 | 5 | 5 | 5 |
| DE63 | | | | | | | | |
| Strawberry | 30 | 30 | 30 | 30 | 0 | 0 | 0 | 0 |
| Puree | | | | | | | | |
| Lemon Juice | 0 | 0 | 0 | 0 | 5 | 5 | 5 | 5 |
| Conc x4 | | | | | | | | |
| Emulsifier | 0.2 | 0.2 | 0.2 | 0.2 | 0.2 | 0.2 | 0.2 | 0.2 |
| LBG | 0.3 | 0.3 | 0.3 | 0.3 | 0.3 | 0.3 | 0.3 | 0.3 |
| Guar | 0.2 | 0.2 | 0.2 | 0.2 | 0.2 | 0.2 | 0.2 | 0.2 |
| Water | 26.3 | 32.7 | 43.3 | 45.9 | 49.8 | 56.3 | 63.3 | 69.3 |
| Properties | | | | | | | | |
| Total Solids | 44 | 38 | 33 | 25 | 44 | 39 | 32 | 26 |
| Total Fat | 0 | 0 | 0 | 0 | 0 | 0 | 0 | 0 |
| Total Sugars | 42 | 36 | 31 | 23 | 46 | 39 | 32 | 26 |
| Ice at −18 C. | 30 | 40 | 50 | 60 | 30 | 40 | 50 | 60 |
| Overrun % | 60-100 | 60-100 | 60-100 | 60-100 | 60-100 | 60-100 | 60-100 | 60-100 |

Examples 1 to 8 were extruded at maximal freezing conditions through a SSHE (Crepaco W04 freezer, series 80 dasher, 150-250 L/hr mix and motor load 80-90%) to assess the possibility of producing a continuous and defined extrusion. This was then also extruded at colder exit temperatures (see below) through a continuous single screw coldextrusion equipment as described in WO98/09536 at a mix throughput of 150-250 L/hr.

The acceptability of the extrusion was assessed after blast hardening (−35° C. for 3 hours) with a dimensional limit required within 10% of the nozzle dimension. However, these changes were mostly visually obvious on extrusion from the appearance of surface melting and slumping and even total collapse of the extrusion.

TABLE 2
Comparative extrusion quality of the sorbet
formulations.

| | SSHE | SSHE | Cold Extrusion | Cold |
|---|---|---|---|---|
| | Extrusion | Extrusion | Temp | Extrusion |
| Example | Temp (° C.) | Quality | (° C.) | Quality |
| 1 | −14 | Not Acceptable | −23 | Acceptable |
| 2 | −10 | Not Acceptable | −20 | Acceptable |
| 3 | −8 | Not Acceptable | −19 | Acceptable |
| 4 | −8 | Acceptable | −17 | Acceptable |
| 5 | −13 | Not Acceptable | −24 | Acceptable |
| 6 | −10 | Not Acceptable | −20 | Acceptable |
| 7 | −8 | Not Acceptable | −19 | Acceptable |
| 8 | −7 | Acceptable | −18 | Acceptable |

### Sherbet/Low Fat Ice Cream Examples

Various sherbet formulations (4% fat ice cream) were also produced.

TABLE 2
Extruded Low Fat Ice Cream Formulations

| | Example | | | |
|---|---|---|---|---|
| | 9 | 10 | 11 | 12 |
| | Product | | | |
| | Sherbet | Sherbet | Sherbet | Sherbet |
| Formulation | | | | |
| Coconut Oil | 4 | 4 | 4 | 4 |
| Skim Milk Powder | 4 | 4 | 4 | 4 |
| Sucrose | 25 | 21 | 15 | 11 |
| Glucose Syrup DE63 | 11 | 8 | 8 | 4 |
| Strawberry Puree | 40 | 40 | 40 | 40 |
| Lemon Juice | 0 | 0 | 0 | 0 |
| MGP | 0.33 | 0.33 | 0.33 | 0.33 |
| LBG | 0.15 | 0.15 | 0.15 | 0.15 |
| Guar | 0.07 | 0.07 | 0.07 | 0.07 |
| Water | 15.45 | 22.45 | 28.45 | 36.45 |
| Properties | | | | |
| Total Solids | 47 | 40 | 34 | 27 |
| Total Fat | 4.4 | 4.4 | 4.4 | 4.4 |
| Total Sugars | 37 | 30 | 24 | 17 |
| Ice at −18 C. | 30 | 40 | 50 | 60 |
| Overrun % | 60-100 | 60-100 | 60-100 | 60-100 |

Examples 9 to 12 were also extruded at maximal freezing conditions through a SSHE (Crepaco W04 freezer, 150-250 L/hr mix, series 80 dasher and motor load 80-90%) to assess the possibility of producing a continuous and defined extrusion.

This was also extruded at colder exit temperatures (see below) through the continuous cold extrusion equipment at a throughput of 150-250 L/hr. As for the sorbets, the extrusion quality was assessed dimensionally.

TABLE 4
Comparative extrusion quality for sherbet
formulations

| | SSHE | SSHE | | Cold |
|---|---|---|---|---|
| | Extrusion | Extrusion | Cold Extrusion | Extrusion |
| Example | Temp (° C.) | Quality | Temp (° C.) | Quality |
| 9 | −10 | Not Acceptable | −19 | Acceptable |
| 10 | −9 | Not Acceptable | −18 | Acceptable |
| 11 | −8 | Not Acceptable | −15 | Acceptable |
| 12 | −5 | Acceptable | −8 | Acceptable |

### Shape Stability

Examples 13 to 15 were extruded under maximal conditions from the SSHE (Crepaco W04 freezer, 150 L/hr mix, motor load 80-90%, extrusion temperature −5 to −10° C.) through dies with different cross sections.

TABLE 5
Sorbet formulations to test shape stability on
extrusion.

| | Example | | |
|---|---|---|---|
| | 13 | 14 | 15 |
| | Product | | |
| | Sorbet | Sorbet | Sorbet |
| Formulation | | | |
| Dextrose | 9 | 3 | 3 |
| Sucrose | 22 | 22 | 15 |
| Glucose Syrup DE63 | 5 | 5 | 5 |
| Orange Juice Conc | 5 | 5 | 5 |
| Whipping Aid | 0.2 | 0.2 | 0.2 |
| LBG | 0.3 | 0.3 | 0.3 |
| Guar | 0.2 | 0.2 | 0.2 |
| Water | 58.3 | 64.3 | 71.3 |
| Properties | | | |
| Total Solids | 38 | 33 | 26 |
| Total Fat | 0 | 0 | 0 |
| Total Sugars | 36 | 31 | 23 |
| Ice at −18 C. | 40 | 50 | 60 |
| Overrun % | 30-80 | 30-80 | 30-80 |

The results are summarised in the following table with a dimensional assessment of whether the extrusion from the SSHE was within 10% of the nozzle dimensions after blast hardening.

TABLE 6
Acceptability of extrusion quality post SSHE
extrusion

| | Ice | Aspect Ratio | | | | | | |
|---|---|---|---|---|---|---|---|---|
| Example | Content % | 0.28 | 0.45 | 0.65 | 0.88 | 1.14 | 1.54 | 2.18 |
| 13 | 40 | Yes | Yes | Yes | No | No | No | No |
| 14 | 50 | Yes | Yes | Yes | No | No | No | No |
| 15 | 60 | Yes | Yes | Yes | Yes | Yes | Yes | Yes |

For the samples where the extrusion was not acceptable (marked “No”) the formulations were also processed through cold extrusion equipment to ensure that they could be extruded within the dimensional constraints of the nozzles. In all cases this was successfully achieved with extrusion temperatures ranging from −8° C. to −14° C.

1. Frozen aerated product containing less than 4.5% w/w fat, having an overrun of between 30% and 120% and an ice content of between 30% and 55% (w/w) at a temperature of −18° C. characterised in that the frozen aerated product is log-shaped and has an aspect ratio of between 0.8:1 and 2:1, preferably between 0.8:1 and 1.5:1.

2. Frozen aerated product according to claim 1 characterised in that the log-shaped frozen aerated product is at least 4 cm high.

3. Frozen aerated product according to claim 1 characterised in that it contains less than 1% w/w stabiliser, more preferably not more than 0.5% w/w.

4. Frozen aerated product according to claim 1 characterised in that it has a total solids content of between 25 and 50% (w/w).
